(19) United States
(12) Patent Application Publication
(10) Pub. No.: US 2026/0211142 A1
(43) Pub. Date: Jul. 23, 2026

(54) METHOD FOR AMBIENT VIBRATION ANALYSIS

(71) Applicant: FNV IP B.V., Leidschendam (NL)

(72) Inventors: Francois JANOD, Leidschendam (NL); Myrna STARING, Leidschendam (NL); Rod EDDIES, Leidschendam (NL)

(73) Assignee: FNV IP B.V., Leidschendam (NL)

(21) Appl. No.: 19/137,755

(22) PCT Filed: Dec. 19, 2023
(86) PCT No.: PCT/EP2023/086514

§ 371 Date: Jun. 11, 2025

(30) Foreign Application Priority Data
Dec. 23, 2022 (NL) 2033828

(51) Int. Cl. G01V 1/30

(52) U.S. Cl. CPC G01V 1/306; G01V 2210/1425; G01V 2210/16

(57) ABSTRACT

A method for determining ground properties of a sub-surface target volume is disclosed. The method comprises measuring ambient noise received from a plurality of surface wave sensors placed along a predetermined grid of locations around a surface of the target volume, the measuring is done with the plurality of surface wave sensors for a predetermined time period to produce noise data. The method also comprises defining a second grid of primary study locations around the surface of the target volume; for each primary study location in the second grid, determining a local Rayleigh wave dispersion curve using the noise data from a selected sub-array of the plurality of surface wave sensors, and concatenating the local dispersion curves for the primary study locations to provide a three-dimensional model of the sub surface properties of the target volume. Unlocking insights from Geo-Data, the present invention further relates to improvements in sustainability and environmental developments: together we create a safe and liveable world.

### TECHNICAL FIELD

The disclosure relates to methods and systems for analysing a target region beneath a surface of the earth. More particularly, the disclosure relates to a method and system for determining one or more ground properties of the sub-surface target region based on ambient noise measured at or near the surface. In particular the disclosure provides methods and systems for providing a shear-velocity model of a sub-surface target region with improved efficiency. Unlocking insights from Geo-Data, the present invention further relates to improvements in sustainability and environmental developments: together we create a safe and liveable world.

### BACKGROUND

There is a general and ongoing need for systems and methods for determining sub-surface ground parameters. In particular, there is a need for systems and methods that can be used to model the properties of a target volume beneath the surface of the earth to provide the information useful for infrastructure planning. Determination of sub-surface ground properties during the early planning phase of construction projects reduces uncertainty during the location determination, foundation design, and construction phases of a project. This in turn reduces delays, overspend, and unnecessary use of material resources (e.g. concrete) during construction.

One key parameter for the determination of ground characteristics in a volume of interest is shear-modulus and shear-velocity Vs. The shear velocity Vs is the velocity at which a shear wave moves through the material and is controlled by the shear modulus of the material. The relationship between shear-velocity and shear modulus G is defined by Vs=√G/ρ, where ρ is the density of the material. Measurement of Vs therefore provides a valuable insight to the ground properties of a sub-surface ground region. Small-strain shear modulus (Gmax) is also important in foundation design, wherein Gmax=ρ·Vs².

Spectral analysis of surface waves (SASW) and multi-channel analysis of surface waves (MASW) are both examples of techniques for gathering surface wave information that can be used in the determination of ground properties in a sub-surface volume. In both of these techniques, surface-level vibrations resulting from an active source (e.g. a weight drop) are measured from and the dispersion of the resulting surface waves is studied. ReMi (Refraction Microtremor) is another surface-level technique that uses ambient noise and surface waves to infer ground properties of a sub-surface region based on the observation of ambient noise at the surface.

Down-hole and cross-hole techniques can also be used to determine ground properties of a sub-surface region. In both of these methods, a receiver located in a bore hole measures waves received from an active source located elsewhere. In a down-hole technique, one of the source and the receiver is located at a sub-surface location within the bore hole and the other of the source and the receiver is located at the surface. In a cross-hole technique, a source is located in a first bore hole, with a receiver located in a second bore hole. In both down-hole techniques, the propagation and dispersion of the received waves are studied to infer the properties of the material through which the waves from the receiver have travelled.

Invasive techniques for measuring material ground properties of a sub-surface region can often present logistical challenges such as long duration of the processes and thus low cost efficiency, e.g. long process set-up, long acquisition times and/or heavy machinery, equipment and processes. Invasive techniques are often particularly undesirable, especially in urban or inaccessible environments, and are often prohibitively expensive. Invasive techniques may also be unfriendly to the environment, e.g. cause disturbance to the local fauna. Conversely, current surface-level techniques may lack the accuracy and reliability of more invasive analysis techniques.

Presently, creating a 3D model using of shear-velocity as a function of depth using known techniques is resource-intensive; a more efficient way to obtain a fast 3D shear velocity model across a target area, defining a target volume is required.

### Overview

A method for determining ground properties of a sub-surface target volume is provided. The method comprises: measuring received ambient noise from a plurality of surface wave sensors located around the surface of a target volume for a predetermined time period, so as to produce noise data. Alternatively, the method may comprise, instead of measuring received ambient noise, receiving a data set indicative of measured ambient noise from a plurality of surface wave sensors located at a surface above a target volume. The method further comprises defining a second grid of primary study locations around the surface of the target volume. The method further comprises, for each primary study location in the second grid: determining a local Rayleigh wave dispersion curve using the noise data from a selected sub-array of the plurality of surface wave sensors, and concatenating the local dispersion curves for the primary study locations to provide a three-dimensional model of the sub surface properties of the target volume.

This method makes the creation of a three-dimensional models of sub-surface properties easier, and more efficient. The use of an existing array of receivers (e.g. geophones) means that AVA analysis can be carried out at any desired location around the surface of a target volume, and the resolution of the resulting model can be higher than in prior art solutions. A model based on a concatenation of dispersion curve information can be created very quickly, and reveals meaningful data about the sub-surface properties of the site in question which can quickly provide go/no go information, for example in the assessment of a site for possible construction work. The creation of the 3D model does not require the tomographic inversion and iterative model generation of the more involved computational methods known in the prior art. The definition of the second grid allows for flexibility in the parameters chosen to generate the 3D model. The study locations can be located anywhere within the target location and the density and number of study locations can be determined as a function of the existing site conditions, as well as the computational resources available for performing the analysis. Note that the term “grid” here may be interpreted as any array of points, either regularly or irregularly located in physical space across the surface of the target volume. Note also that “surface” of the target volume is not to be taken in a strict literal sense, but implies along an upper region of the target volume; any individual sensor may be on top of the surface, partially submerged in the surface, or the body of the sensor may be located wholly beneath the surface, depending on the best conditions for measuring the ambient wavefield.

In some implementations determining the local Rayleigh dispersion curves comprises: defining a range of discrete study frequencies, the range extending from a minimum study frequency, Fmin, to a maximum study frequency, Fmax, defining a maximum wavelength, λmax, for each study frequency, and defining a frequency dependent sub-array for each study frequency, each frequency dependent sub-array comprising only surface wave sensors located up to a predetermined distance corresponding to λmax from the respective study location, and determining the local Rayleigh wave dispersion curves comprises using the noise data from the frequency dependent sub-arrays for each study frequency. This optional method of defining a frequency dependent sub array takes advantage of the existing array to the fullest effect, by allowing for a maximum and minimum frequency to be defined, which in effect allows for the range of phase velocity information extractable from the dispersion curves to be optimised. For each frequency under consideration at each study location (ie point on the secondary grid) the sensors that are located within a max radius are included in the analysis for the dispersion curve, the max radius corresponding to the max wavelength. Again, choosing sensors in this way allows for the inclusion of as many or as few sensors as required at the locations chosen to compute dispersion curves. Both the site locations, and the characteristics to be determined at each location, based on the selection of the sensors around the location, may be flexibly chosen to optimise the results. This in general leads to a much denser output that in current AVA systems.

In some implementations defining a frequency dependent sub-array further comprises: determining a theoretical array response for the sub-array, and upon determining that the theoretical array response does not satisfy a frequency condition, moving the respective study location to a secondary study location at which a second theoretical array response satisfies the frequency condition. The array response of a given array, which may be selected according to various metrics, as defined herein, will vary depending on the arrangement and number of sensors selected. It may be determined that the array response for a selected sub-array of sensors will lead to results that, after correlation of the received signals, do not allow for the determination of a maximum on the dispersion curve, for a given frequency, or the array may be such that the array response is effectively “blind” to Rayleigh waves coming from a specific direction—which will degrade the range or quality of information that may be extracted from the resulting dispersion curve, and hence the ultimate three-dimensional model. As such, when such an array response is identified, the study location may be moved to a location at which the array response does satisfy the resolution requirements at required frequencies, due to a more desirable spatial arrangement of the sensors around the second location. This tweaking of the sites of the individual grid points of the study locations allows for optimisation of the resolvable Rayleigh waves at each site, and will provide a better 3D model, while maintaining the efficient and simpler computation provided by the disclosed method.

In some implementations moving the study location comprises determining that in the secondary location the frequency condition is satisfied. The array response at a secondary location can be reviewed and it can be determined, for example by an iterative process, that the array response at the secondary location meets predetermined criteria relating to the information required from the dispersion curve at that location.

In some implementations determining the local Rayleigh dispersion curves further comprises: defining a set of incident azimuth directions; defining a range of Rayleigh velocity, (V_{R}) values, for each velocity value in the range, phase-correcting the noise data for each incident azimuth direction, and performing a frequency-domain summation of the phase-corrected data across all azimuths, creating an output matrix of the summed data of the form A(f,V_{R}), where A represents amplitude, and f represents frequency.

In some implementations phase corrected data corresponding to a signal S(f,x,y) received at sensor M(x,y) for a given azimuthal angle theta, and a velocity value, v, is of the form:

Sc(f,x,y)=S(f,x,y)*exp(2iπfdx/v)

Where dx is equal to the distance of M0 along the direction of propagation, θ, being of the form:

dx=(x−x0)*cos(θ)+(y−y0)*sin(θ).

In this implementation, M0 is a reference sensor, and x0 and y0 are the coordinates of the reference sensor M0. These references can be attributed to any point, which may function as a reference point for the propagation of the signal.

In some implementations concatenating the local dispersion curves comprises: locating a plurality of peaks on the local dispersion curve for each study location, each peak having a frequency component and a Rayleigh velocity component, converting the frequency component into a depth value, converting the Rayleigh velocity component into a shear-velocity, Vs, component and for each study location, plotting the shear velocity components for each depth value for each study location on a three-dimensional model. The straightforward conversion of the peaks from the dispersion curve into a 3D model of the shear wave velocities at differing depths around the target volume is a highly efficient and novel way to obtain sub-surface information quickly, from a series of existing sensors. The depth values may straightforwardly be converted from the frequency values of the peaks, (using Z=lambda/3 and lambda=V_{R}/f) and the shear velocity may be straightforwardly calculated from the identified Rayleigh velocities using a conversion factor of V_{R}=V_{S}*0.92.

In some implementations the method further comprises, after defining the second grid of study locations, removing any study location from the grid satisfying one of: having below a predetermined number of geological sensors within a predetermined distance having geological sensors within a predetermined distance that collectively satisfy one or more spatial location rules. In some implementations the one or more spatial location rules comprise at least one of: the centroid of the geological sensors within the predetermined distance is further from the study location than half an inter-study location distance of the grid of study locations, and fewer than a pre-determined number of geological sensors lie one on side of a chord drawn through the study location. This is a simple and efficient method for ensuring that each of the study locations contributes meaningful data to the resulting dispersion curve, and may be considered an alternative to the adjustment of the study locations described above. Instead of using the array response function, it may be determined that a given study location on the grid does not have enough sensors located in its vicinity and so the study location may straightforwardly be removed from the analysis. Equally, spatial relations of the sensors may be reviewed prior to or instead of reviewing an array response function, and where, for example a highly asymmetrical arrangement of sensors is identified, again the study location may be removed.

In some implementations the local dispersion curve represents one-dimensional information. In some implementations concatenating the local dispersion curves comprises combining the 1D information to form 3D information. The concatenation of the 1D dispersion curves into a 3D model without the need for a full tomographic inversion provides an efficient way of reviewing the properties of a sub-surface target volume in a quicker and more efficient manner.

According to another aspect of the present disclosure, there is provided a system comprising: one or more processors; one or more memories having stored thereon computer readable instructions configured to cause the one or more processors to perform operations comprising the steps set out above.

According to another aspect of the present disclosure, there is provided a computer readable medium comprising instructions, that, when executed by one or more data processing apparatus, cause the one or more data processing apparatus to perform operations comprising the steps of any of the methods disclosed herein.

According to another aspect of the present disclosure, there is provided a computer program comprising instructions which, when the program is executed by a computer, cause the computer to perform any of the methods disclosed herein.

### BRIEF DESCRIPTION OF THE DRAWINGS

Disclosed implementations will now be described by way of example to illustrate aspects of the disclosure and with reference to the accompanying drawings, in which:

FIG. 1 shows a cross-sectional view of a sub-surface target region with a plurality of receivers arranged at the surface;

FIG. 2 shows a plot identifying the ray paths between a plurality of receivers;

FIG. 3 shows an alternative view of an array of geophysical sensors

FIG. 4 shows an array of geophysical sensors having a secondary grid of study locations identified

FIGS. 5A, 5B, and 5C show a graphical representation of the obtaining of dispersion curve information from a study location

FIG. 6 shows a three-dimensional plot of dispersion curve peak information

FIG. 7 shows an interpolation of the dispersion curve information

FIG. 8 shows a method corresponding to the present disclosure

FIG. 9 shows a further method according to the present disclosure;

FIG. 10 shows a further method according to the present disclosure;

FIG. 11 shows a further method according to the present disclosure;

FIG. 12 a 3D model of seismic shear-wave velocity (Vs) for a sub-surface target region

FIG. 13 shows a block diagram of a computing device which can be used to implement the disclosed methods.

### DETAILED DESCRIPTION

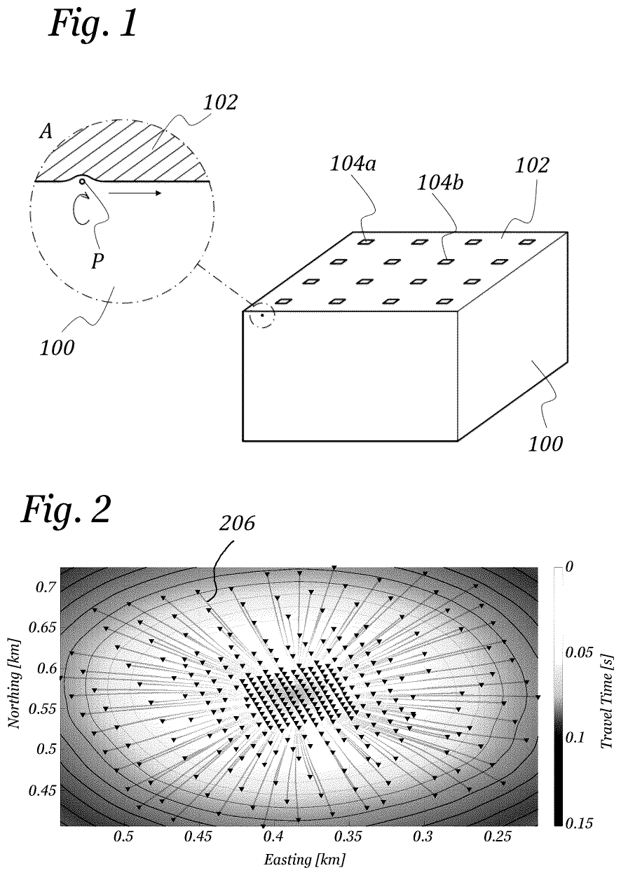

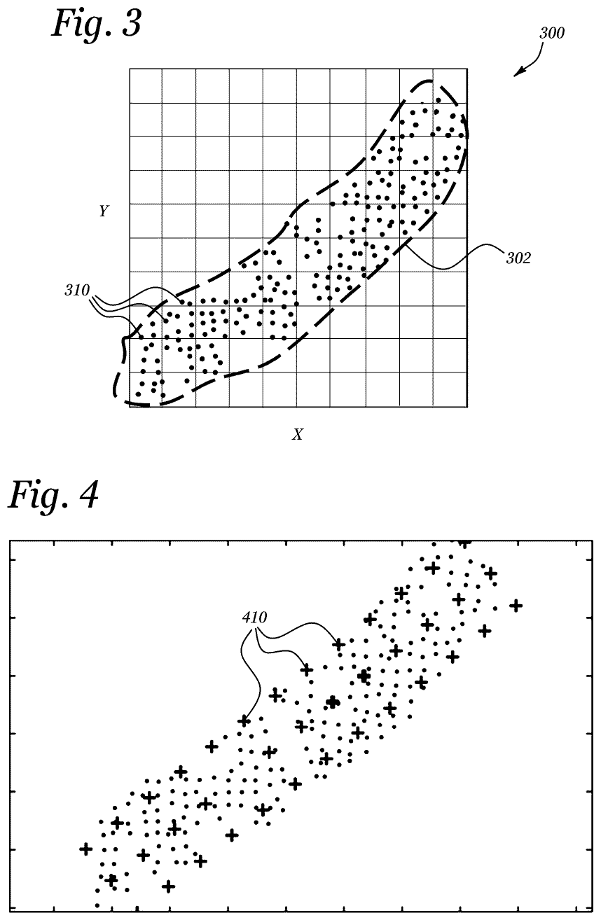

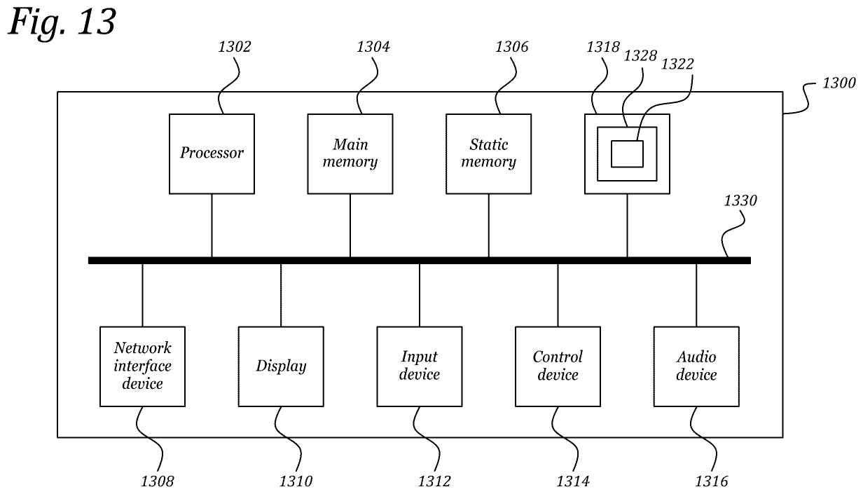

This detailed description describes, with reference to FIGS. 1 and 2, an approach to measuring structural properties of a ground volume using receivers, such as geophones. Next, with reference to FIGS. 3-10, novel methods for creating a model of properties of the sub-surface of the ground volume using ambient vibration analysis are disclosed. Finally, a computing device that may be used to perform the disclosed methods is described with reference to FIG. 13.

The following examples will be described in the context of a geophone array, to aid understanding. It will, however, be appreciated that the disclosed systems and methods are applicable to a variety of receiver types, including but not limited to geophones, accelerometers, seismometers, vibration sensors and/or transducers. The disclosed methods may be applied to analysis of any suitable set of signals for the purpose of ambient vibrational analysis.

Before turning to the details of the disclosed cross-correlation methodology, some background relating to determination of surface and sub-surface properties using receivers will first be provided.

The present disclosure describes systems and method for determining the ground properties of a sub-surface volume. Although, it will be appreciated that the methods herein may be applied to model physical properties other than shear velocity, such as compressional wave velocity, density, elastic modulus, or, if a viscoelastic model is being used, optionally also viscosity coefficients Qₛ and Qₚ. In general, the model may define multiple physical property values, the focus of the following detailed description will be the determination of shear velocity, and the related quantity, shear modulus.

Shear modulus is a measure of the elastic shear stiffness of a material and represents the deformation of a solid when it experiences a force parallel to one of its surfaces while its opposite face experiences an opposing force. Such forces and their effects in sub-surface ground volumes, are an important parameter for study before and during the design of building and infrastructure projects. To determine the shear modulus of a volume, the shear velocity, Vs, is determined. This in turn gives an indication of the stiffness of the sub-surface material, and its ability to support structures extending above and/or through the volume.

In the context of ground study, two types of waves are generally distinguished: P-waves, in which particles in the volume oscillate in the direction of movement of the wave, cause a compression and de-compression of the ground as the waves propagate through the ground. S-waves are shear waves, in which particles oscillate in a direction perpendicular to the direction of propagation of the waves.

P-waves and S-waves are body waves and propagate in all directions through the body of the volume. The interaction of P- and S-waves with the earth's surface generates surface waves, which propagate along that surface. Several types of surface waves can be distinguished. In the systems and methods described herein, Rayleigh waves are measured and studied because it is convenient to measure the vertical component of surface vibrations. However, it will be appreciated that other surface waves (e.g. Love waves) may be measured and harnessed in the systems and methods described herein.

Because surface waves propagate in 2D (at the surface), they attenuate less rapidly than body waves (which propagate in 3D). Surface waves are generally present within a depth range of one wavelength from the surface, generally travel more slowly and have a predominantly lower frequency than body waves. This lower attenuation, slower travel time and lower frequency of surface waves makes their study particularly attractive for the purposes of determining shear velocity, Vs. Since the surface waves have lower attenuation, the signal strength is better maintained through over a longer travel distance. The resulting measurement results therefore generally have a higher signal quality (signal-to-noise ratio) than body wave studies.

The methods and systems of the present disclosure harness the study of surface waves to provide insight into the ground properties of a sub-surface target volume. In general terms, the present disclosure provides methods for analysing one or more ground properties, such as the shear-wave velocity, Vs, of a sub-surface target region. The method involves receiving a data set indicative of ambient noise at a surface above a sub-surface target region, analysing the background wavefield to study the dispersive behaviour of the surface waves measured at the surface, and determining the ground properties of the sub-surface target region based on the study of the dispersive behaviour of the observed waves.

Referring now to FIG. 1, a cross-sectional view of a sub-surface volume 100 is shown. A surface 102 extends above the sub-surface volume. Surface waves propagate along the surface 102, as shown at point A, where a schematic representation of a particle oscillation (due to Rayleigh wave propagation) at the surface above the target sub-surface volume is shown. As illustrated, the oscillation of the particle P is partly vertical, partly in the direction of propagation and movement is therefore substantially ellipsoid.

At a surface 102 above the volume 100, a plurality of receivers 104a, 104b is arranged in a 2D array. The receivers (collectively referred to as 104) may be receivers configured to measure the vertical component of the surface waves propagating across the surface 102. However, it will be appreciated that the propagation of surface waves may also be measured with alternative sensing means, for example: accelerometers, seismometers, vibration sensors, and/or transducers.

The receivers 104 are configured to measure ambient noise. That is, the wavefield present due to background noise (as opposed to noise from an active source such as a hammer drop or explosion). The background noise may be natural (e.g. due to lapping ocean waves, wind, and other naturally occurring vibrations) or cultural (e.g. due to human activity, including traffic, machinery, etc.).

As shown in FIG. 1, the receivers 104 are arranged in a grid array at the surface, the grid extending in two directions. It should be noted that the surface above the target region may, in many cases, not be planar. The array of receivers 104 may therefore not be truly “2-dimensional” (each receiver may be offset from its neighbours in the grid in the z-direction, as well as the x- and y-directions). However, such a grid arrangement of receivers will be referred to as a 2D array herein. It will also be appreciated that in the context of sub-surface ground study, the term 2D array may also be used to denote an array configured to capture 2D information (e.g. a line of receivers configured to provide information regarding a 2D slice of a target region) and a 3D array may refer to a grid of receivers configured to capture 3D information. However, in the context of the present information, the term 2D in the context of receivers is intended to refer to the 2-dimensional configuration of the receivers rather than the information gathered.

Moreover, although the receivers 104 are shown at the surface in FIG. 1, the receivers 104 may also be disposed near the surface (e.g. partially buried, or immediately beneath the surface). In the context of the present application, ‘at the surface’ will be understood to mean at or near the surface, such that the receivers measure surface waves.

In the schematic shown in FIG. 1, the receivers 104 are arranged in a regular grid, with the inter-receiver distance equal across surface 102. However, in some implementations, the receivers 104 are arranged with varying density across the surface 102.

The array of receivers 104 shown in FIG. 1 can be used to gather a data set indicative of ambient noise at a surface above a sub-surface target region for which a model of shear velocity Vs is desired that is the subject of the present application.

To determine the shear velocity from the observation of surface waves (in particular Rayleigh waves), the dispersive behaviour of the surface waves is studied. Surface waves are dispersive, i.e. their velocity is dependent on frequency. Since seismic velocities increase with depth in the earth, normal surface wave dispersion shows a decrease of surface-wave velocity with increasing frequency. It is by studying the behaviour of surface waves at a surface above a volume that the ground properties of the volume can be determined.

There are two ways to measure the velocity of dispersive surface waves and a distinction is made between the determination of group velocity or phase velocity.

The group velocity of a wave is the velocity with which the overall envelope shape of the wave's amplitudes—known as the modulation or envelope of the wave—propagates through space. The group velocity is equivalent to the speed with which the energy of the wave propagates through the volume and is measured by determining the wave propagation between two points. The group velocity is obtained as a time-of-flight (that is, travel time) measurement between a (virtual) source and a receiver.

The phase velocity is the velocity at which the phase of any one frequency component of the wave travels. As such, the phase velocity is expressed as a function of frequency. To measure the phase velocity, at least two measurement nodes (e.g. receivers) are chosen to measure the waves propagating through the volume to determine relative time-of-flight between the nodes for different frequencies. The result is the phase velocity as a function of frequency as averaged over the volume between the two measurement nodes. Phase velocity is acquired as a point in 2D phase space (dispersion spectrum) which is itself obtained by a 2D transform (such as slant-stack, Radon, FK, or the like) of an array of recorded waveforms (time-distance space). The wavelength of the surface wave is indicative of its propagation depth. As a result, the phase velocity as a function of frequency is indicative of the shear velocity Vs as a function of depth.

The receivers 104 at surface 102 provide the measurement nodes for the study of the surface wave behaviour as described above. However, the receivers 104 described above are configured to record passive noise. Therefore, the measurement nodes of FIG. 1 do not represent a real point source and associated receiver. However, receivers 104 can act as a virtual source receiver pair, as explained below.

Receivers 104a and 104b form a first receiver pair in the array at surface 102. Neither receiver 104a nor 104b represents a point source for noise recorded at the other of receiver 104a, 104b. However, by cross-correlating the received signal at receiver 104a and 104b, receivers 104a and 104b can act as a (virtual) source receiver pair, where each receiver of the pair records a signal as though the signal had originated at the other of the pair. The cross-correlation is performed using the principle of interferometry.

The cross-correlation of passive noise measured at respective pairs of receivers at the surface shown in FIG. 1 can be used to reproduce a response from the sub-surface target volume, as if it were induced by an impulse point source, which is equal to Green's function.

In other words, a response that is received by cross-correlating two receiver recordings can be interpreted as a response that would have been measured at one of the receiver locations as if there were a source at the other. Various approaches to determining the Green's function for a virtual source-receiver pair are known, with an overview of the approaches described in “Tutorial on Seismic Interferometry: Part 1—Basic Principles and Applications”; GEOPHYSICS. Vol. 75, No 5 (September-October 2010; P.75A195075A209; Wapenaar et al.).

In FIG. 1, only one pair of receivers is labelled (104a, 104b). However, it will be appreciated that for each receiver 104 in the array, every other receiver in the array may act as the other half of a source receiver pair. In this manner, the Green's function for each source receiver pair may be obtained. The Green's functions across the plurality of virtual source receiver pairs is studied to determine the dispersive behaviour of the surface waves.

FIG. 2 shows a plurality of virtual source-receiver pairs across a surface above a sub-surface region of interest. Ray paths 206 between source-receiver pairs are indicated. Note that the ray paths here indicate the propagation of a wave (modelled from) a virtual source at a receiver in a centre of the plot to each of the other receivers in the array. The receivers are not labelled individually but are represented with an inverted triangle in the plot. Each receiver can similarly act as a point source. As can be seen from FIG. 2, the array of receivers allows source receiver pairs defining ray paths that extend in different directions, and with varying inter-receiver spacing. The background shading and contour rings indicate the travel-time field from the central receiver to the other receivers 104. There are also corresponding ray paths between each receiver and all other receivers, i.e. between every pair of receivers. These ray paths are not depicted in FIG. 2 for simplicity.

Following acquisition of data indicative of ambient noise, and the analysis of said ambient noise data to model a plurality of response signals at a plurality of virtual source-receiver pairs, the received data may now be used to determine the ground properties of the sub-surface target volume by solution of an inverse problem, in which the response at the receivers (e.g. receivers 104) is known but the ground properties of the sub-surface target volume is not (yet) known.

The starting model for the solution of the inverse problem may be determined in multiple ways since it sets initial physical property values, for example for Vs, within the sub-surface target volume, to be refined by solution of the inverse problem. The starting model can comprise historical data based on known local or regional data, predicted values based on selective invasive test methods, coarse surface level studies or a theoretical model based on local or regional historical knowledge. Although the starting model is to be improved upon and need not be a particularly accurate representation of the sub-surface target region, the more accurately the starting model reflects the physical properties of the sub-surface target region, the more accurate the final model of the ground properties of the target region will be. Therefore, improvements in the starting model can provide an improved output for the methods and systems described herein.

Once a starting model has been selected, the inverse problem can be solved via inversion in which a model of shear wave velocity against depth is iteratively improved to obtain a best match (for example using least squares, deterministic or gradient descent techniques) of the predicted dispersion curve from the starting model (obtained for example using forward modelling for example through the Haskell Thomson matrix approach) against the curve determined from measurements. Various techniques are well known for inversion operations as will be apparent to the skilled reader. It will be noted that this 1 D derivation of shear velocity from surface wave velocity has to assume horizontal homogeneity (shear wave velocity as a function of depth only), hence the limited dimensionality.

Ambient noise, as described herein, refers to ambient vibrations of the ground caused by sources such as tide, water waves striking the coast, effect of wind on trees or buildings, industrial machinery, cars and trains, or human footsteps, etc. The “signal” which is measured in ambient array measurement techniques may be considered to be Rayleigh waves, which are deemed to originate from sources that are far enough away that they satisfy a plane-wave approximation.

We now define a process of ambient vibration analysis and improved methods for carrying out such analysis and methods for building on the results of the ambient vibration analysis.

Ambient Vibration Analysis (AVA) may be carried out with directional sensors installed on the ground in a two dimensional array, and correlation and processing of the received signals can be used to create a one dimensional dispersion curve, providing information on the velocity of Rayleigh waves at different frequencies, from which can be derived a shear-wave velocity, Vs, profile down to relatively large depths. Passive seismic surveys permit the measurement of dispersion of waves from low frequencies of 0.2-5 Hz to frequencies of 10-30 Hz—having wavelengths of over 200 m to shorter wavelengths of 5 m-80 m. The range of measurable wavelengths (and therefore the depth over which the measurement is made) is influenced by the spacing (or density) of the receivers in the array—that is, the maximum distance between two receivers relates to the max wavelength λₘₐₓ, and the distance between the closest placed sensors determines the minimum observable wavelength, and thus determines the resolution of the array.

A general rule of thumb is that the expected maximum investigation depth possible will be between P=λₘₐₓ/3 and λₘₐₓ/2.

### Standard Array Geometry for AVA

Since the source positions of ambient waves impinging on the array are inherently generally unknown within the wavefield of received ambient vibration, it is preferable (however not necessary), to perform AVA analysis using a two-dimensional array having no preferential direction—for this reason, ideally arrays of sensors which have no preferential direction such as circular arrays of sensors located around a target location may be used. This allows for the accurate measurement of waves arriving in the wavefield of the array from different directions due to the fact that the array will respond in a similar way to waves from each direction. In order to overcome low-resolution provided by a limited number of sensors, measurements may be repeated by performing repeated measurements with circular arrays of different sizes.

Vertical velocity sensors may be used to obtain the information required for AVA, though three-dimensional sensors may also be used for this purpose.

The skilled reader will be aware that Ambient Vibrational Analysis of an array of sensors may be performed by various techniques, for example the spatial auto-correlation technique (SPAC), and also the f-k beamforming technique, which will now be briefly described. The ambient data are collected by the sensors and the data are processed in the frequency-wavenumber (f-k) domain—the data may be transformed by Fourier transform in various known ways—to provide a distribution of recorded energy for a specific time block for a wavenumber representation for each frequency. The resulting distribution may show an amplitude maximum or maxima in the plane of X and Y wavenumbers, and a maximum may define the vector wavenumber and directional information of the wave propagating at that particular frequency. The phase velocity of the wave may then be determined using the relationship between wavenumber and Rayleigh Velocity V_{R}

$$\\ {V}_{R} = \frac{2 π f}{k}$$

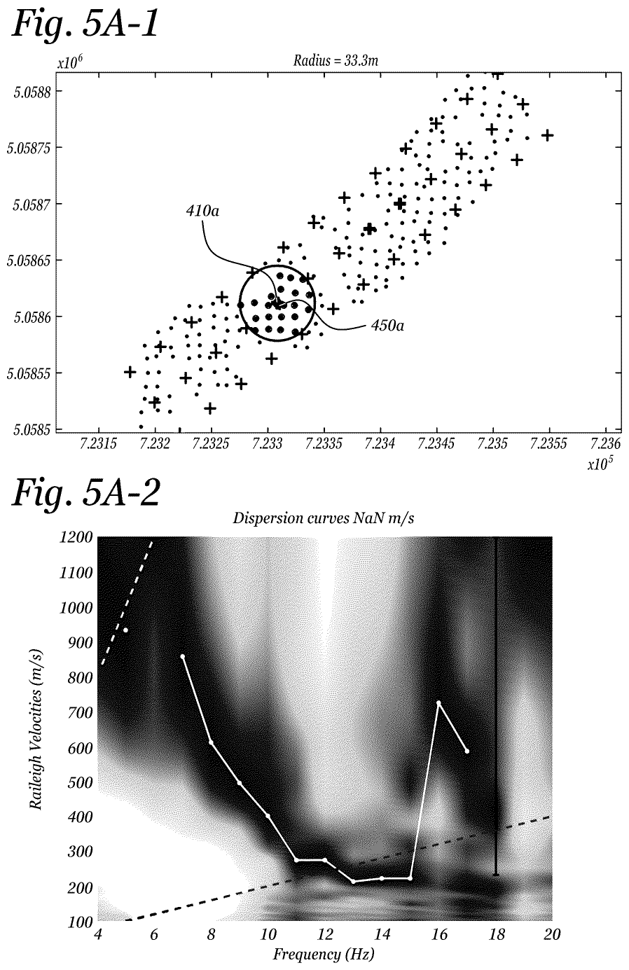

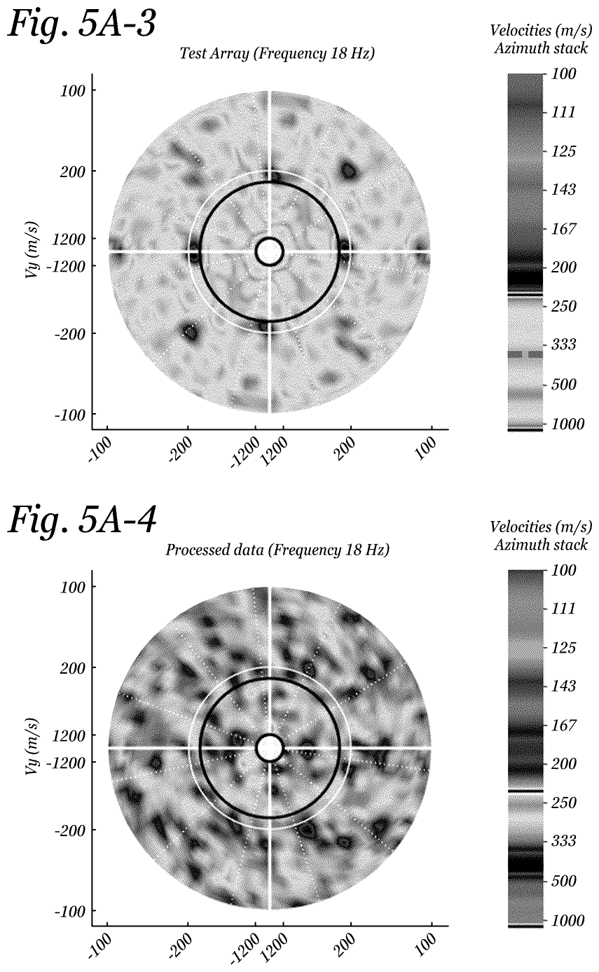

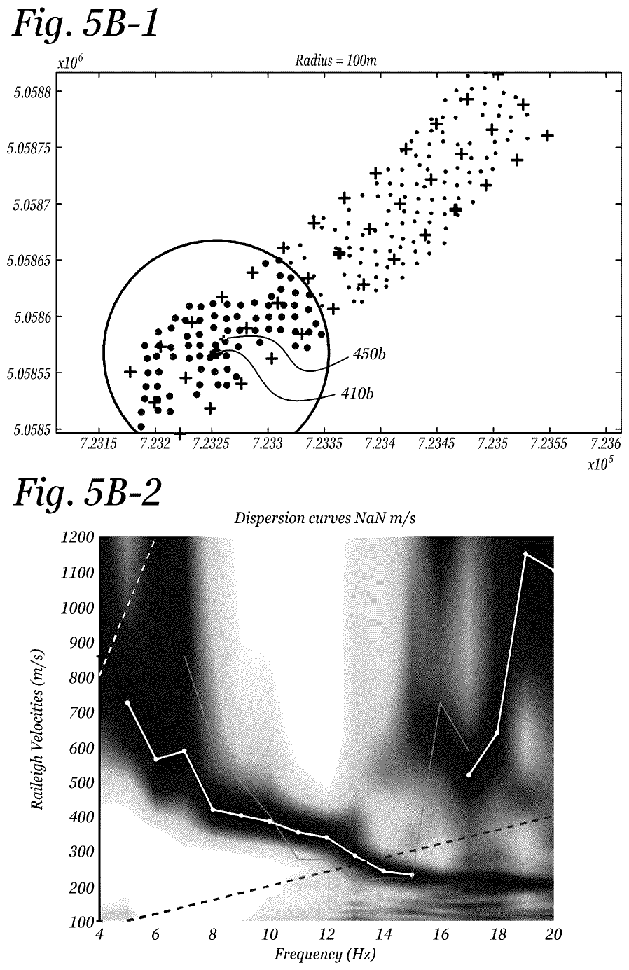

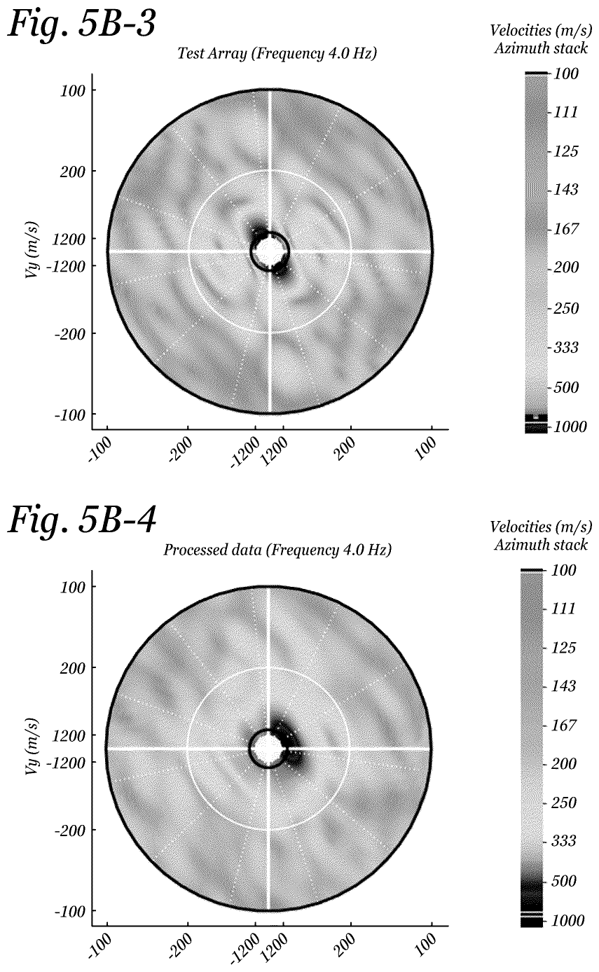

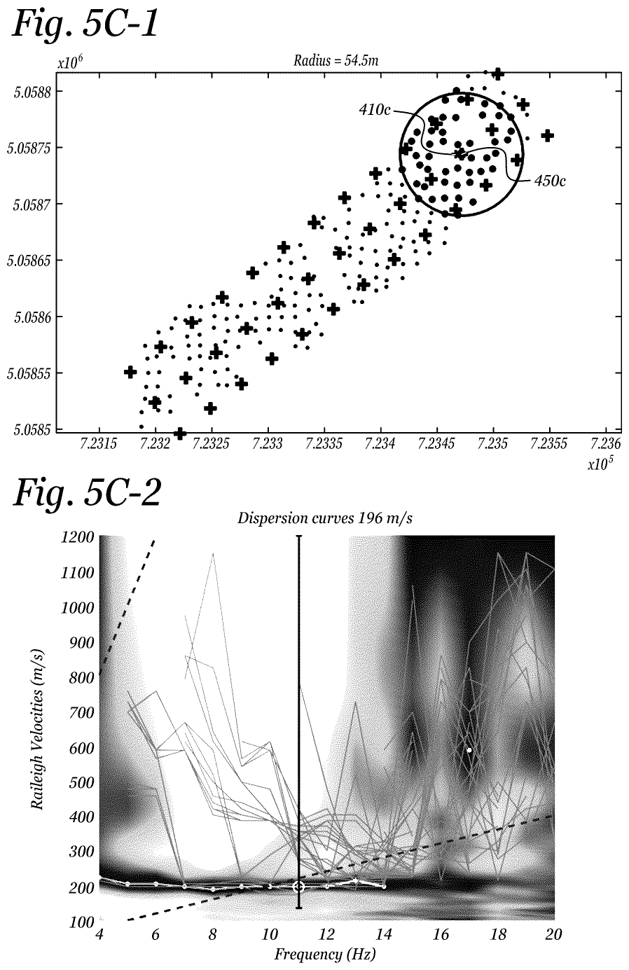

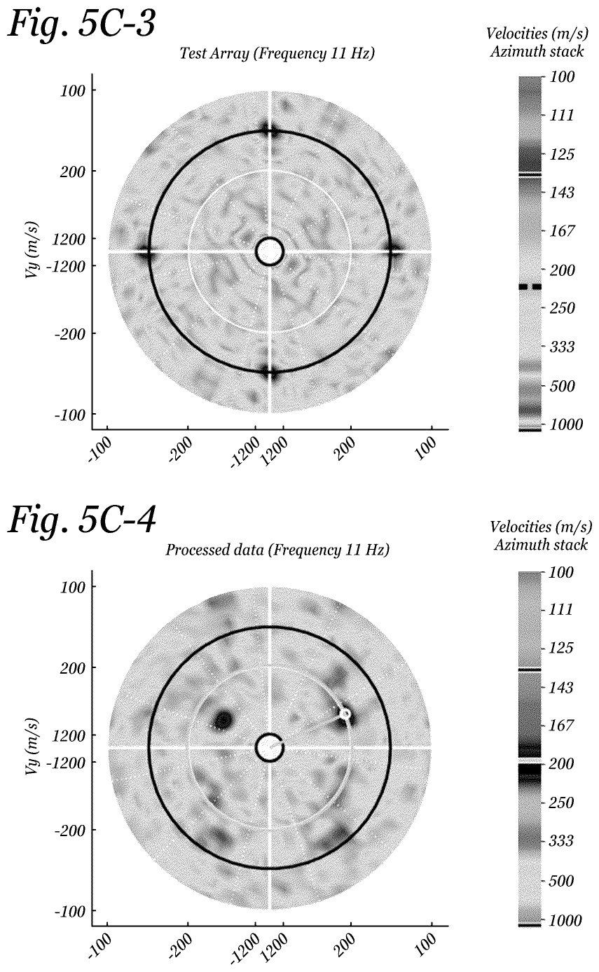

The dispersion image is obtained by stacking amplitude images obtained for each time block. This results in the dispersion images such as that seen in FIGS. 5a-5c frequency, an effective histogram of the measured V_{R} values may be created for each time block of received noise data.

### System and Associated AVA Method for Producing a 3D Model of a Sub-Surface Target Volume

It has been recognised that some of the limitations of the AVA systems mentioned above, including arrays of a handful of sensors. In the present disclosure, it is likely that the arrangement of the receivers may not be of the form of a regular array geometry. In general, there is a trade-off between the available number of sensors and the array function (or array transfer function, which relates to the array resolution at large wavelengths and aliasing related to short wavelengths)—more sensors in the array provides for higher resolution information, while the orientations of sensors may mean that there are azimuthal effects which affect the resolvable wavefield information (ie in certain directions the derivable wave information may be lower resolution, or may cut off at a frequency, high or low, beyond which it might be desirable to have information collected.

FIG. 3 shows a simple representation 300 of the distribution of a large number of sensors 310, located around an area 302, and that are to be used for a ground study of the volume under the study area 302. The sensors relate to the geophysical sensors described in the foregoing.

While in general AVA analysis is performed by setting up a specific array of vertical velocity sensors adequate for the recording of passive Rayleigh wave data, the present disclosure relies on a pre-existing array of receivers arranged on a target area above a target volume. A secondary regular grid may then be defined across the whole acquisition area defined by the array, and the grid points of the secondary grid may be used as a centre for AVA processing.

FIG. 4 shows the same array of sensors with a grid of desired study locations 410 spread about the surface. The grid of study locations is shown to be a regular grid, which can provide for ease of interpolation of the subsequent data, however the grid may be irregular, at least in part, depending on site-specific or other conditions. The grid of points to be used for AVA processing is defined across the acquisition area according to the existing spacing of the receivers, prior knowledge regarding the properties of the sub-surface, and the required velocity range. The grid points define the points at which it is desired to evaluate a dispersion curve. The density of grid points will ultimately provide the spatial resolution of the 3D model across the surface of the sub-surface target area (that is, the x, and y resolution, where z relates to depth).

A regular grid of study locations may be defined for the study grid; this allows for straightforward interpolation of the Rayleigh velocity data from the dispersion curves into subsequent calculation and modelling of the subsurface properties, for example in a tomographic inversion process.

As described, a non-regular grid of study locations may be used, and the non-regular grid may be an iterative improvement or adjustment of an initially defined regular grid. That is, a regular grid may be defined and it may be identified for a particular study location or set of study locations, either from a straightforward analysis of the physical location of the study location(s) and the sub-array of sensors which surround it (for example a highly irregular arrangement of receivers within a given radius might be identified, or it might be identified that a grid location has no sensors on one side, or a highly linear distribution of sensors might be present), or from an analysis of the array response function of the sensors that lie within a specific radius, that the selected sub array has an array response function which would preclude the obtaining of meaningful data within a required frequency range. The study location may be adjusted within the grid of study locations to a location with an improved array response function, to provide more clarity in the resulting 3D model. The provision of the secondary grid allows for assessment of the ambient wavefield where it would not otherwise be possible, using a standard array technique.

As can be seen from the foregoing, using a dense pre-existing array of sensors and defining a grid of study locations allows for a freedom in the selection of grid points which will depend on the site-specific characteristics of the sub-surface volume under consideration, as well as the restrictions relating to computational requirements in producing the 3D model.

A user may set various parameters in the calculations done on data collected from the system of vibrational geophysical sensors arranged over a target area for which various parameters are user definable. This means that the subsequent processing steps can be quickly determined by a user prior to performing the detailed analysis. A user can set the number of azimuthal directions from which to take measurement. The user can define a range of velocities over which to study target area user can set a minimum velocity Vmin and a maximum velocity Vmax and then subsequently define a number of velocities within the range to be studied. The user can also define a range of frequencies by defining a minimum frequency Fmin and a maximum frequency Fmax in Hertz and define a frequency Delta to determine how many over how many frequencies calculations will be performed.

Examples of data that is to be gathered from an array now follow. The geometric array of the illustrated sensors, and the resulting array response information and resulting dispersion curves are provided for illustrative purposes, and the exact position of sensors or values used in the measurement axes should not be understood to be anything other than exemplary.

Turning now to FIG. 5A, portions 1 to 4, information relating to the dispersion of Rayleigh waves at a particular study location is shown. The spatial distribution is shown in FIG. 5A-1, the theoretical and real array responses are shown in FIGS. 5A-3 and 5A-4, and the dispersion curve is in FIG. 5A-2. The dispersion curve is generated according to the methods described herein. The axis labels on FIGS. 5A-1, 5B-1 and 5C-1 may be take to be indicative and for illustration only and different ranges and scales may be used.

The underlying array of receiver locations can be seen in the x y coordinate diagram. The secondary grid of study locations has been overlaid over the study area, and one example study location 410a has been selected, towards the south-westerly end of the study area, and the study radius of 33.3 metres has been defined The sensors which are located within that radius of 33.3 metres are highlighted on FIG. 5A-1. The study radius of 33.3 m relates to a study frequency of 18 Hz, in this case. Also shown in the figure is the centroid 450a of the sensors that are defined within the study radius. It is noted that for each different study radius, the centroid 450a may be located at a different spatial location away from the study location.

The sensors within the study radius will have a theoretical array response, based on the number and spatial arrangement of sensors—this array response can be seen in FIGS. 5A-3 and 5A-4. and it can be seen that the array has relative (theoretical) peaks in the North-South and East-West directions. In the lower right region of the figure the processed correlated data can be seen, and it is clear that there is no identifiable peak of Rayleigh wave velocities. FIG. 5A-3 shows, for a given frequency, the amplitude response of the array to incident plane waves, according to azimuth and velocity: data is phase shifted according to velocity and distance along direction, and then summed up. FIG. 5A-3 gives only array response, since a signal is chosen as having the same phase at every station, which is obviously not the case in reality. FIG. 5A-4 uses the effectively measured data to show a the actual response of the array, in response to the real ambient wavefield.

This is also clear from the dispersion curve in FIG. 5A-2—at 18 Hz, the frequency under consideration, the amplitude of the frequency/Rayleigh velocity data contains no easily definable maximum. The dispersion curve shows that, for the other measured frequencies between 6 and 16 Hz the dominant Rayleigh velocity can be identified and peaks are identified on the curve. The dispersion curve contains an upper and a lower dashed line which represent a low resolution cut off to the curve and a region below which aliasing effects become stronger, respectively, meaning that although peaks in the data may be found in this region, they may be considered less reliable than those lying in the area between the lines.

A similar layout is shown in FIGS. 5B. FIG. 5B-1 shows a study location further to the southeast has been selected, with a study radius of 100 metres and it can be seen that many more of the receivers in the array are included in the study area to be processed. Radius of 100 m shown for that study location relates an array response for 4 Hz. It can be seen that the array response is highly directional in this case, due to the difference between the maximum spacing of the sensors in the NE/SW direction (“along” the main array) vs the NW/SE direction (“across” the array, due to the large radius (ie. wavelength) at this low frequency. It can also be seen that the processed measured does not necessarily provide a meaningful maximum at this frequency that is resolvable on the dispersion curve. The array response (left graph) is unisotropic (as the array is) and shows high amplitudes down to 300 m/s at certain directions. Thus the peak at 800 m/s (seen in the right graph) may not be meaningful. However, taking into account azimuth, one may see that this peak comes from a well resolved azimuthal direction (East/North-East) and may be accepted as is.

Turning to FIGS. 5C, it can be seen that the last of the study locations in the second grid is selected, this time with a steady radius of 54.5 metres and the relevant receivers in the array are highlighted. The dispersion curve at this frequency indicates a strong maximum across all frequencies from 4 Hz to 14 or 15 Hz, and this indicates a homogenous propagation across the depth of the target volume. It can be seen from the processed data diagram that a strong peak is identifiable at a Rayleigh velocity of 200 m/s.

The dispersion relations shown in FIGS. 5A-2, 5B-2 and 5C-2 show a greyscale rendering of an amplitude matrix of V_{R} and frequency A(V_{R}, f), with the darker sections corresponding to higher amplitudes. On each diagram, peaks may be identified at the maxima (shown by white dots, and the dispersion curve is signified by the line which joins the maxima.

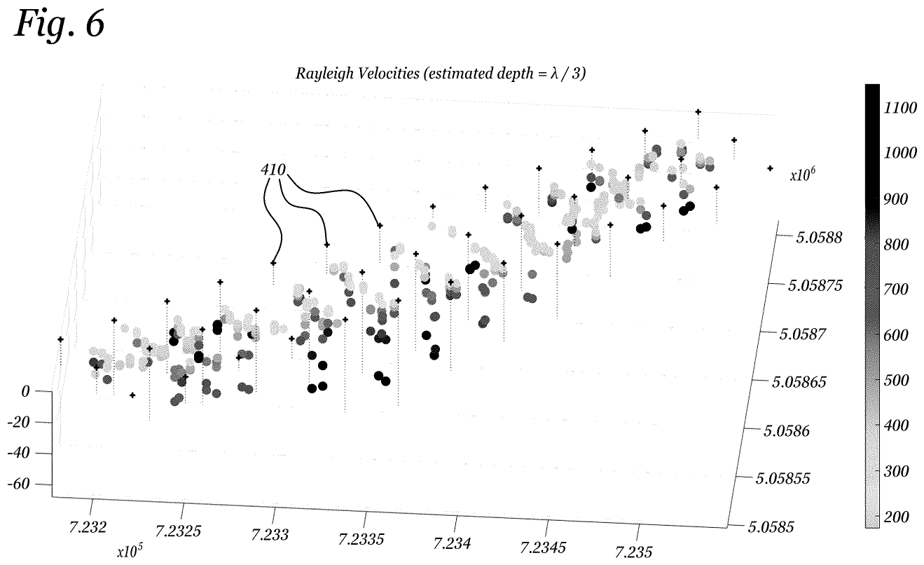

Once dispersion curve information relating frequency to Rayleigh wave velocity have been processed for each study location from which information is required, the dispersion curve information may straightforwardly be plotted across a 3D model of the study locations, as shown in FIG. 6. The study locations 410 are shown in the figure, which dispersion curve information laid out on the z-axis, below the study location points. The estimated depths are defined by a simple rule of thumb that depth=lambda/3—and lambda can be extracted from the frequency information on the dispersion curve.

The topographical points defined by the grid points in the study locations can be chosen on the basis of number of receiver sensors that are laid out in the field. Since there are many more sensors laid out than usual AVA cases allows for denser and better imaging of higher frequencies as well as to lysing different propagation azimuths once the grid of study locations is defined, process of eliminating study locations for which there are not sufficient receivers within predetermined radius comma or for which receivers based in a highly irregular pattern may be discounted from the subsequent method steps for example, for those study locations which have sensors located in highly irregular relationships. It is noted that the dispersion curve information points for each depth are plotted at the location of the centroid for which that particular frequency dependent sub-array of sensors was determined. The grayscale information shows the wave velocity for the given depth at that study location.

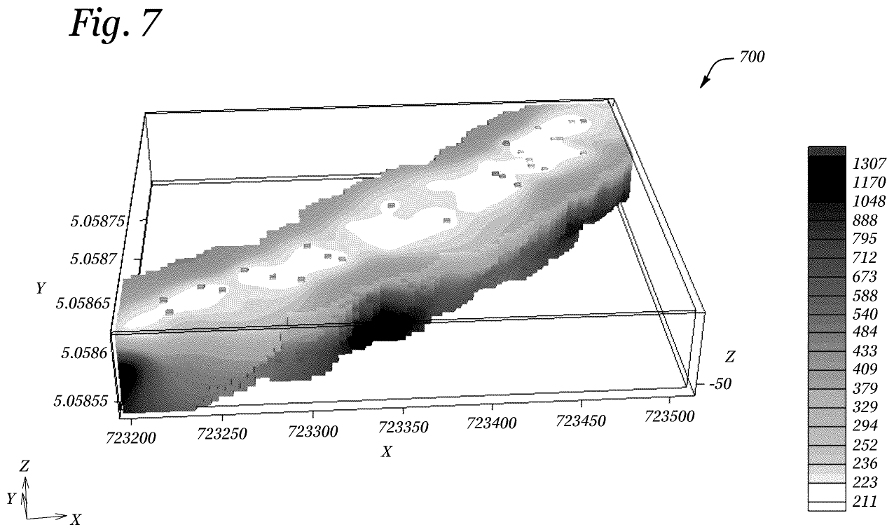

The information from FIG. 6 may be straightforwardly interpolated into the information shown in FIG. 7, which is a 3D model of the sub-surface Shear-wave properties of the target volume. Any suitable method for interpolation may be used in order to best visualise the sub-surface volume and highlight the properties that are relevant to the purpose of the modelling. The 3D model generated as described herein, and relating to phase velocities, may be provided as a starting model for a more detailed 3D model created utilising tomographic inversion techniques and incorporating group velocity dispersion characteristics, and provides an improved starting point for such analysis when compared to known techniques.

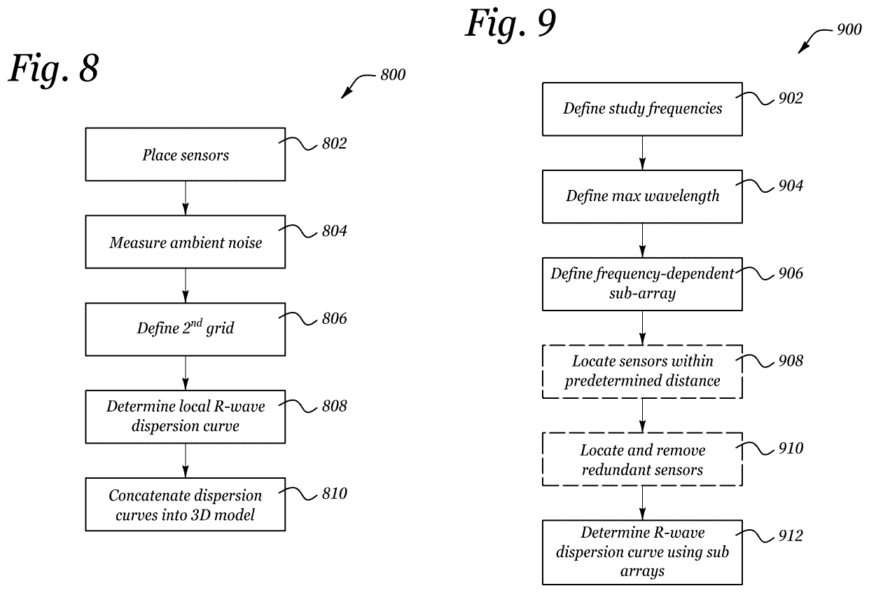

FIG. 8 shows a flow chart of a method 800 for creating a 3D model of ground properties of a sub-surface target volume according to the present disclosure. In optional step 802, sensors are placed at locations around the surface of a target volume. The sensors may be any sensor as described above, capable of detecting surface wave information. The sensors may be located on the surface itself, or partially or wholly below a surface layer. The sensors may be placed at regular intervals, or not, as dependent on the site conditions and any prior assumptions or knowledge about the geological properties of the sub surface.

In step 804, ambient noise information is collected by the sensors and may be saved as “noise data”. The collection of ambient noise information may take place over a defined extended time window to collect enough data for the necessary processing, and may subsequently be partitioned into smaller time windows for processing. In step 806, the secondary grid of study locations at which AVA processing is desired is defined. The grid may be defined prior to the collection of the ambient noise information, and the properties and locations of the study locations may be defined or adjusted as described herein.

At step 808, the local Rayleigh wave dispersion curve is determined for each study location in the secondary grid from the collected noise data, according to the methods described herein. The Rayleigh wave dispersion information may be further analysed to define maxima in the data for frequency/R-wave velocity pairs to define the dispersion curve. The step of determining the dispersion curves may comprise defining a set of incident azimuth directions; defining a range of Rayleigh velocity, (V_{R}) values, for each velocity value in the range: phase-correcting the noise data received at the sensors in a sub array around the study location for each incident azimuth direction, and performing a frequency-domain summation of the phase-corrected data across all azimuths, creating an output matrix of the summed data of the form A(f,V_{R}), where A represents amplitude, and f represents frequency. The matrix of output data is that shown in the dispersion curves in FIGS. 5a-5c.

At step 810, the dispersion curve information for each study location and relating frequency to Rayleigh wave velocity may be concatenated and plotted in 3D space to produce a 3D model of the wave properties of the target volume at each study location, as a function of depth. The data points that are taken from the one dimensional dispersion curves may be plotted on the 3D model and interpolated to produce a 3D image of the target area. This approach is highly efficient and speeds up the acquisition of a 3D model from sensor data through the straightforward conversion from the 1D dispersion relation information shown in the dispersion curves to a 3D model.

A further method according to the present disclosure is outlined in FIG. 9. This method may form part of the method described above and may apply to each of the study locations, as appropriate. At step 902, the frequencies to be studied may be defined. The maximum and minimum frequencies for study, Fmax and Fmin, and a number of frequencies to be studied may be identified. Fmax and Fmin, as well as the number of frequencies in the range to be studied, may be selected for all of the study locations in the secondary grid collectively, or may be determined on a per-study location basis. For example, prior knowledge of a site may mean that at one extremity a particular value for Fmin is used, while at an opposing extremity know to have different geological conditions a different value of Fmin may be used, thus obtaining dispersion information relating to differing depths at different locations. At step 904 the maximum wavelength may be defined. The maximum wavelength relates to the maximum depth under consideration, and is related to the maximum and minimum velocities under consideration, Vmax and Vmin. At steps 906 and 908 the sub array for each of the study frequencies is determined—based on the frequency under study. The sub-array comprises all sensors lying within a radius of the study location that is related to the frequency by the relation λₘₐₓ=Vₘₐₓ/f). The sub array comprises the sensors from which data will be analysed to create the R-wave dispersion curves for each study location, which are determined in step 912.

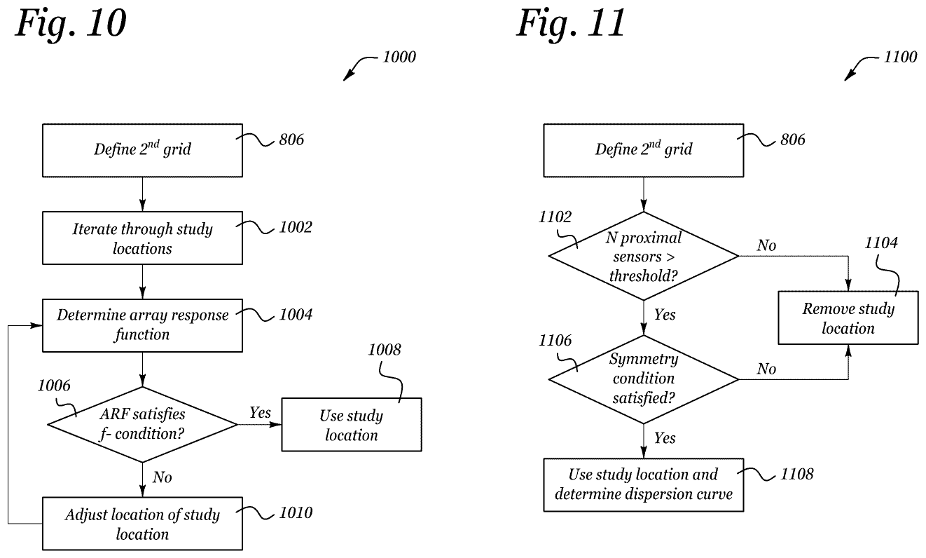

The definition of the secondary grid may comprise optional further steps, which are outlined in FIG. 10. The method may comprise, iteratively for each study location, or a subset of the study locations (1002), determining the array response function of the sub-array (step 1004). The array response may demonstrate a high directionality or that aliasing effects will make it impossible to determine a dispersion wave peak for a particular study frequency—this may be verified in step 1006. A frequency condition may be predetermined that should be satisfied by the sub-array; i.e that the array is able to resolve incoming waves across the full frequency range, and across all or most of the azimuthal directions under study. If the sub-array response at the study location satisfies the condition then the study location may be used (1008) and the dispersion curve information obtained for the study location. If it is determined that the array response is not satisfactory with respect to a specific frequency, frequency range or direction, the location of the study location may be adjusted and a new array response function determined for the sub-array (which is) determined at the new study location. The process may be iterated until a location is found that is associated with a sub-array have an array response that satisfies the frequency condition. If no study location within a predetermined distance from the original study location has a suitable frequency response, the study location may be omitted from the grid of study locations, and no dispersion curve data determined for that location.

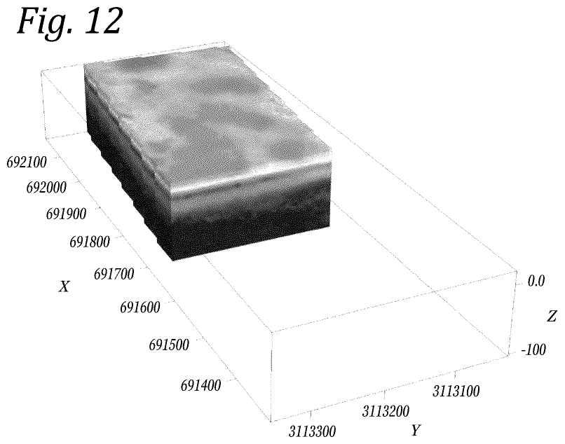

A further method 1100 for the definition of a secondary grid is shown in FIG. 11, and may form part of step 806 of method 800. For a study location in the secondary grid of study locations, a plurality of sensors within the predetermined distance (ie within the defined radius) may be defined as a sub array. At step 1102 it is determined whether the number of sensors in the sub-array is above a predetermined threshold. If there are not enough sensors within the defined radius of the study location, the study location may be removed from the analysis at step 1104. At step 1106 the symmetry of the sub-array of sensors may be assessed. It may be determined (step 1108) that for a particular azimuthal direction through the study location that fewer than a predetermined percentage, e.g. 10% of the sensors of the sub-array lie within a half-space through the node, and in this case, the study location may be removed from the analysis. Where more than the predetermined percentage of sensors of the sub array lie within every given half space as defined by any azimuth, the study location may be used and the dispersion curve determined, as above.

We note that various steps shown in the methods described in the foregoing may be performed in an order other than that shown, and various steps are optional improvements.

In the present approach, a method has been described in which a grid of (frequency dependent) sub-arrays of receivers are defined through a grid of study locations located across a main array, the study locations and sub arrays are definable according to the methods outlined above, and gathered data are analysed for phase dispersion using the AVA approach by a 2D transform from the time-distance to the phase velocity-frequency or wavenumber-frequency domains. A 3D (horizontal spatial coordinates, frequency) distribution of phase dispersion is achieved by generating (overlapping, depending on source-receiver offset range needed) rectangular patches of receiver and assigning the AVA dispersion curve to the centre of each patch.

FIG. 12 shows a 3D shear-wave velocity Vs model for a sub-surface target region of interest. Vs is indicated for a given location in the 3D volume by the shade/colour of the map at that point. Although the model is shown here as a block for a 3D volume of interest, it will be appreciated that horizontal slices may be viewed, or that that the model view may be manipulated to show material within the sub-surface target volume having target material properties. For example, the model can be used to isolate and display a target layer of interest within the target volume.

By providing a 3D model of the ground properties of sub-surface target volume, such as the model shown in FIG. 12, the systems and methods described herein can reduce uncertainty during infrastructure planning, design and construction.

FIG. 13 shows a block diagram of one implementation of a computing device 1300 within which a set of instructions, for causing the computing device to perform any one or more of the methodologies discussed herein, may be executed. In alternative implementations, the computing device may be connected (e.g., networked) to other machines in a Local Area Network (LAN), an intranet, an extranet, or the Internet. The computing device may operate in the capacity of a server or a client machine in a client-server network environment, or as a peer machine in a peer-to-peer (or distributed) network environment. The computing device may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine.

Further, while only a single computing device is illustrated, the term “computing device” shall also be taken to include any collection of machines (e.g., computers) that individually or jointly execute a set (or multiple sets) of instructions to perform any one or more of the methodologies discussed herein.

More particularly, a number of computing devices can be used to compute cross-correlations of signal data subsets independently and in parallel, as described above. Each computing device may have the structure shown in FIG. 13. Alternatively, a plurality of processors within a single computing device, such as computing device 1300, can perform the independent computations.

The example computing device 1300 includes a processor 1302, a main memory 1304 (e.g., read-only memory (ROM), flash memory, dynamic random access memory (DRAM) such as synchronous DRAM (SDRAM) or Rambus DRAM (RDRAM), etc.), a static memory 1306 (e.g., flash memory, static random access memory (SRAM), etc.), and a secondary memory (e.g., a data storage device 1318), which communicate with each other via a bus 1330.

Processor 1302 represents one or more general-purpose processors such as a microprocessor, central processing unit, or the like. More particularly, the processor 1302 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 1302 may also be one or more special-purpose processors such as an application specific integrated circuit (ASIC), a field programmable gate array (FPGA), a digital signal processor (DSP), network processor, or the like. Processor 1302 is configured to execute the processing logic (instructions 1322) for performing the operations and steps discussed herein.

The computing device 1300 may further include a network interface device 1308. The computing device 1300 also may include a video display unit 1310 (e.g., a liquid crystal display (LCD) or a cathode ray tube (CRT)), an alphanumeric input device 1312 (e.g., a keyboard or touchscreen), a cursor control device 1314 (e.g., a mouse or touchscreen), and an audio device 1316 (e.g., a speaker).

It will be apparent that some features of computer device 1300 shown in FIG. 13 may be absent. For example, one or more computing devices 1300 may have no need for display device 1310 (or any associated adapters). This may be the case, for example, for particular server-side computer apparatuses 1300 which are used only for their processing capabilities and do not need to display information to users. Similarly, user input device 1312 may not be required. In its simplest form, computing device 1300 comprises processor 1302 and memory 1304.

The data storage device 1318 may include one or more machine-readable storage media (or more specifically one or more non-transitory computer-readable storage media) 1328 on which is stored one or more sets of instructions 1322 embodying any one or more of the methodologies or functions described herein. The instructions 1322 may also reside, completely or at least partially, within the main memory 1304 and/or within the processor 1302 during execution thereof by the computer system 1300, the main memory 1304 and the processor 1302 also constituting computer-readable storage media.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid state memory, magnetic tape, a removable computer diskette, a random access memory (RAM), a read-only memory (ROM), a rigid magnetic disc, and an optical disk, such as a CD-ROM, CD-R/W or DVD.

In an implementation, the modules, components and other features described herein can be implemented as discrete components or integrated in the functionality of hardware components such as ASICS, FPGAs, DSPs or similar devices.

A “hardware component” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase “hardware component” should be understood to encompass a tangible entity that may be physically constructed, permanently configured (e.g., hardwired), or temporarily configured (e.g., programmed) to operate in a certain manner or to perform certain operations described herein.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

Unless specifically stated otherwise, as apparent from the following discussion, it is appreciated that throughout the description, discussions utilizing terms such as “receiving”, “determining”, “identifying,” or the like, refer to the actions and processes of a computer system, or similar electronic computing device, that manipulates and transforms data represented as physical (electronic) quantities within the computer system's registers and memories into other data similarly represented as physical
quantities within the computer system memories or registers or other such information storage, transmission or display devices.

It is to be understood that the above description is intended to be illustrative, and not restrictive. Many other implementations will be apparent to those of skill in the art upon reading and understanding the above description. Although the present disclosure has been described with reference to specific example implementations, it will be recognized that the disclosure is not limited to the implementations described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A method for determining ground properties of a sub-surface target volume, comprising:
measuring ambient noise received from a plurality of surface wave sensors placed along a predetermined grid of locations around a surface of the sub-surface target volume, the measuring done for a predetermined time period to produce noise data;
defining a second grid of primary study locations around the surface of the sub-surface target volume;
for each primary study location in the second grid, determining a local dispersion curve using the noise data from a selected sub-array of the plurality of surface wave sensors; and
concatenating the local dispersion curves for the primary study locations to provide a three-dimensional model of the ground properties of the surface target volume.

2. The method according to claim 1, wherein determining the local dispersion curves comprises:
defining a range of discrete study frequencies, wherein the range extending from a minimum study frequency, Fmin, to a maximum study frequency, Fmax,
defining a maximum wavelength, λₘₐₓ, for each study frequency, and
defining a frequency dependent sub-array for each study frequency, each frequency dependent sub-array comprising only surface wave sensors located up to a predetermined distance corresponding to λₘₐₓ from a respective study location, and
determining the local dispersion curves comprises using the noise data from the frequency dependent sub-arrays for each study frequency.

3. The method according to claim 2, wherein defining the frequency dependent sub-array further comprises:
determining a theoretical array response for the frequency dependent sub-array, and upon determining that the theoretical array response does not satisfy a frequency condition,
moving the respective study location to a secondary study location at which a theoretical array response satisfying the frequency condition.

4. The method according to claim 3, wherein moving the respective study location comprises determining that in the secondary study location the frequency condition is satisfied.

5. The method according to claim 1, wherein determining the local dispersion curves further comprises:
defining a set of incident azimuth directions;
defining a range of velocity, (V_{R}) values,
for each velocity value in the range:
phase-correcting the noise data for each incident azimuth direction, and
performing a frequency-domain summation of the phase-corrected noise data across all azimuths,
creating an output matrix of summed data of a form A(f,V_{R}), where A represents amplitude, and f represents frequency.

6. The method according to claim 5, wherein phase corrected data corresponding to a signal S(f,x,y) received at sensor M(x,y) for a given azimuthal angle theta, and a velocity value, v, is of the form:
$$\\ Sc ( f , x , y ) = S ( f , x , y ) * exp ( 2 i π fdx / v )$$
Where dx is equal to a distance of M0 along a direction of propagation, being of the form:
dx=(x−x0)*cos(theta)+(y−y0)*sin(theta), wherein M0 is a reference sensor, and x0 and y0 are coordinates of the reference sensor M0.

7. The method according to claim 1, wherein concatenating the local dispersion curves comprises:
locating a plurality of peaks on the local dispersion curve for each study location, each peak having a frequency component and a velocity component;
converting the frequency component into a depth value;
converting the velocity component into a shear-velocity component; and
for each study location, plotting the shear-velocity components for each depth value for each study location on a three-dimensional model.

8. The method according to claim 1, further comprising, after defining the second grid of study locations,
removing any study location from the second grid satisfying one of:
having below a predetermined number of geological sensors within a predetermined distance having geological sensors within a predetermined distance that collectively satisfy one or more spatial location rules.

9. The method according to claim 8, wherein the one or more spatial location rules comprise at least one of:
a centroid of the geological sensors within the predetermined distance is further from the study locations than half an inter-study location distance of the second grid of study locations, and
fewer than a pre-determined number of geological sensors lie one on side of a chord drawn through the study locations.

10. The method according to claim 1, wherein the local dispersion curve represents one-dimensional information.

11. The method according to claim 10, wherein concatenating the local dispersion curves comprises combining one-dimensional information to form 3D information.

12. The method according to claim 1, wherein the ground properties comprises a 3D model of one or more of:
shear wave velocity;
shear modulus;
density; and
elastic modulus.

13. A system comprising:
one or more processors;
one or more memories having stored thereon computer readable instructions configured to cause the one or more processors to:
measure ambient noise received from a plurality of surface wave sensors placed along a predetermined grid of locations around a surface of a sub-surface target volume, the measuring done for a predetermined time period to produce noise data;
define a second grid of primary study locations around the surface of the sub-surface target volume;
for each primary study location in the second grid, determine a local dispersion curve using the noise data from a selected sub-array of the plurality of surface wave sensors; and
concatenate the local dispersion curve for the primary study locations to provide a three-dimensional model of ground properties of the sub-surface target volume.

14. (canceled)

15. The system according to claim 13, further comprising instructions, which when executed by the one or more processors, causes the one or more processors to:
define a range of discrete study frequencies, wherein the range extending from a minimum study frequency, Fmin, to a maximum study frequency, Fmax,
define a maximum wavelength, λₘₐₓ, for each study frequency, and
define a frequency dependent sub-array for each study frequency, each frequency dependent sub-array comprising only surface wave sensors located up to a predetermined distance corresponding to λₘₐₓ from a respective study location, and
determine the local dispersion curve comprises using the noise data from the frequency dependent sub-arrays for each study frequency.

16. The system according to claim 15, further comprising instructions, which when executed by the one or more processors, causes the one or more processors to:
determine a theoretical array response for the frequency dependent sub-array, and upon determining that the theoretical array response does not satisfy a frequency condition,
move the respective study location to a secondary study location at which a theoretical array response satisfying the frequency condition.

17. The system according to claim 16, wherein moving the respective study location comprises determining that in the secondary study location the frequency condition is satisfied.

18. The system according to claim 13, further comprising instructions, which when executed by the one or more processors, causes the one or more processors to:
define a set of incident azimuth directions;
define a range of velocity, (V_{R}) values,
for each velocity value in the range:
phase-correct the noise data for each incident azimuth direction, and
perform a frequency-domain summation of the phase-corrected noise data across all azimuths,
create an output matrix of summed data of a form A(f,V_{R}), where A represents amplitude, and f represents frequency.

19. The system according to claim 18, wherein phase corrected data corresponding to a signal S(f,x,y) received at sensor M(x,y) for a given azimuthal angle theta, and a velocity value, v, is of the form:
$$\\ Sc ( f , x , y ) = S ( f , x , y ) * exp ( 2 i π fdx / v )$$
where dx is equal to a distance of M0 along a direction of propagation, being of the form:
dx=(x−x0)*cos(theta)+(y−y0)*sin(theta), wherein M0 is a reference sensor, and x0 and y0 are coordinates of the reference sensor M0.

20. The system according to claim 13, further comprising instructions, which when executed by the one or more processors, causes the one or more processors to:
locate a plurality of peaks on the local dispersion curve for each study location, each peak having a frequency component and a velocity component;
convert the frequency component into a depth value;
convert the velocity component into a shear-velocity component; and
for each study location, plot the shear-velocity components for each depth value for each study location on a three-dimensional model.

21. The system according to claim 13, further comprising instructions, which when executed by the one or more processors, causes the one or more processors to:
remove any study location from the second grid satisfying one of:
having below a predetermined number of geological sensors within a predetermined distance having geological sensors within a predetermined distance that collectively satisfy one or more spatial location rules.
